(19) United States
(12) Patent Application Publication
(10) Pub. No.: US 2014/0254568 A1
(43) Pub. Date: Sep. 11, 2014

(54) SEMICONDUCTOR MODULE

(71) Applicant: Murata Manufacturing Co., Ltd., Nagaokakyo-shi (JP)

(72) Inventor: Masashi MARUYAMA, Nagaokakyo-shi (JP)

(73) Assignee: MURATA MANUFACTURING CO., LTD., Nagaokakyo-shi (JP)

(21) Appl. No.: 14/147,612

(22) Filed: Jan. 6, 2014

(30) Foreign Application Priority Data
Jan. 17, 2013 (JP) 2013-006537

(51) Int. Cl. H04J 3/02

(52) U.S. Cl. CPC H04J 3/02
USPC 370/336

(57) ABSTRACT

A semiconductor module includes a first transmission circuit outputting a first transmission signal of a first wireless communication system based on time-division multiplexing, a second transmission circuit outputting a second transmission signal of a second wireless communication system based on time-division multiplexing, and a switch circuit outputting a reception signal from an antenna, as a first reception signal of the first wireless communication system or a second reception signal of the second wireless communication system, outputting the first transmission signal and the first reception signal in a time division manner, and outputting the second transmission signal and the second reception signal in a time division manner.

### BACKGROUND OF THE INVENTION

1. Field of the Invention

The present invention relates to a semiconductor module.

2. Description of the Related Art

A semiconductor module, used for wireless communication and used in a mobile terminal such as a cellular phone, is desired to be compatible with a plurality of wireless communication systems. Specifically, for example, in some cases a semiconductor module is required to be compatible with a plurality of communication methods such as Time Division Synchronous Code Division Multiple Access (TD-SCDMA) serving as one of 3rd Generation (3G) communication methods and Time Division Long Term Evolution (TD-LTE) serving as one of 3.9th (3.9G) Generation communication methods, in addition to Global System for Mobile Communications (GSM) (registered trademark) serving as one of 2nd Generation (2G) communication methods.

For example, Japanese Unexamined Patent Application Publication No. 2007-300156 discloses a front-end module that is compatible with such plural communication methods (FIG. 1). The front-end module disclosed in Japanese Unexamined Patent Application Publication No. 2007-300156 is compatible with four communication methods including Extended GSM (EGSM), Digital Cellular System (DCS), Personal Communication Service (PCS), and the TD-SCDMA.

The front-end module illustrated in FIG. 1 in Japanese Unexamined Patent Application Publication No. 2007-300156 uses a large number of switching mechanisms so as to be compatible with the four communication methods. Specifically, a diplexer separating signals of a low-frequency band and a high-frequency band is provided immediately below an antenna, a switch used for switching between the transmission and reception of the EGSM and a switch used for switching between the transmission and reception of the DCS/PCS and TD-SCDMA are provided immediately below the diplexer, and furthermore, a switch used for switching between the transmission and reception of the TD-SCDMA is provided. In such a configuration, since a communication signal passes through a plurality of switching mechanisms, the loss of a signal becomes large in some cases.

### SUMMARY OF THE INVENTION

Accordingly, preferred embodiments of the present invention significantly reduce the loss of a communication signal in a semiconductor module that is compatible with a plurality of wireless communication systems.

According to preferred embodiments of the present invention, a semiconductor module includes a first transmission circuit configured to output a first transmission signal of a first wireless communication system based on time-division multiplexing, a second transmission circuit configured to output a second transmission signal of a second wireless communication system based on time-division multiplexing, and a switch circuit configured to be capable of outputting a reception signal from an antenna, as a first reception signal of the first wireless communication system or a second reception signal of the second wireless communication system, outputting the first transmission signal and the first reception signal in a time division manner, and outputting the second transmission signal and the second reception signal in a time division manner.

According to various preferred embodiments of the present invention, it is possible to reduce the loss of a communication signal in a semiconductor module compatible with a plurality of wireless communication systems.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a diagram illustrating an example of a configuration of a communication unit including a power amplifier module according to a preferred embodiment of the present invention.

FIG. 2 is a diagram illustrating a configuration of a front-end module in a first preferred embodiment of the present invention.

FIG. 3 is a diagram illustrating a configuration of a front-end module in a second preferred embodiment of the present invention.

FIG. 4 is a diagram illustrating a configuration of a front-end module in a third preferred embodiment of the present invention.

FIG. 5 is a diagram illustrating an example of a configuration of a matching circuit having a wider bandwidth.

FIG. 6 is a diagram illustrating an example of a configuration of a commonly-used matching circuit.

FIG. 7 is an immittance chart of a matching circuit having a wider bandwidth.

FIG. 8 is an immittance chart of a commonly-used matching circuit.

FIG. 9 is a diagram illustrating a configuration of a front-end module in a fourth preferred embodiment of the present invention.

### DETAILED DESCRIPTION OF THE PREFERRED EMBODIMENTS

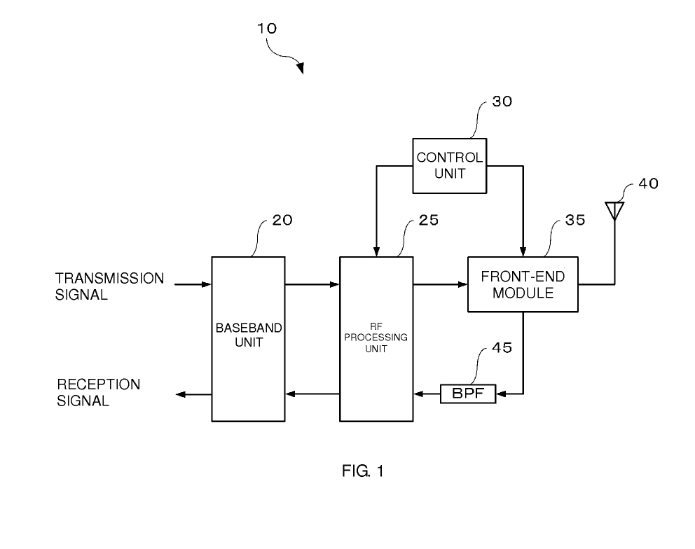

Hereinafter, preferred embodiments of the present invention will be described with reference to drawings. FIG. 1 is a diagram illustrating an example of the configuration of a communication unit including a front-end module according to a preferred embodiment of the present invention. For example, in a mobile communication device such as a cellular phone, a communication unit 10 is used to transmit and receive various kinds of signals such as sounds and data to and from a base station.

As illustrated in FIG. 1, the communication unit 10 includes a baseband unit 20, an RF processing unit 25, a control unit 30, a front-end module 35, an antenna 40, and a band pass filter 45.

The baseband unit 20 is capable of converting a transmission signal into an IQ signal to output the IQ signal and converting an IQ signal input from the RF processing unit 25 into a reception signal to output the reception signal.

The RF processing unit 25 is capable of modulating the IQ signal on the basis of a wireless communication system such as the GSM, the TD-SCDMA, and the TD-LTE and generating a high-frequency (RF) signal used to perform wireless transmission. In addition, the RF processing unit 25 is capable of demodulating an RF signal received through the antenna 40, on the basis of the wireless communication system, and outputting the IQ signal. In addition, the RF processing unit 25 is compatible with a plurality of wireless communication systems, and capable of generating RF signals of a plurality of frequency bands. The frequency band of the RF signal ranges from about several hundred MHz to about several GHz, for example.

The control unit 30 is arranged and programmed to control modulation and demodulation in the RF processing unit 25 and controlling signal transmission and reception in the front-end module 35.

In response to the control by the control unit 30, the front-end module 35 is capable of outputting the RF signal through the antenna 40 and outputting, to the band pass filter 45, the RF signal received through the antenna 40. While the configuration of the front-end module 35 will be described later, the front-end module 35 is capable of amplifying the power of the RF signal to a level necessary to transmit the RF signal to the base station, and output the RF signal.

The band pass filter (BPF) 45 extracts a signal whose band corresponds to the frequency band of the wireless communication system, from the RF signal output from the front-end module 35, and outputs the signal to the RF processing unit 25. In addition, the BPF 45 is capable of including filter circuits whose number corresponds to the frequency band with which the communication unit 10 is compatible.

Hereinafter, first to fourth preferred embodiments (front-end modules 35A to 35D) serving as examples of the configuration of the front-end module 35 will be described.

### First Preferred Embodiment

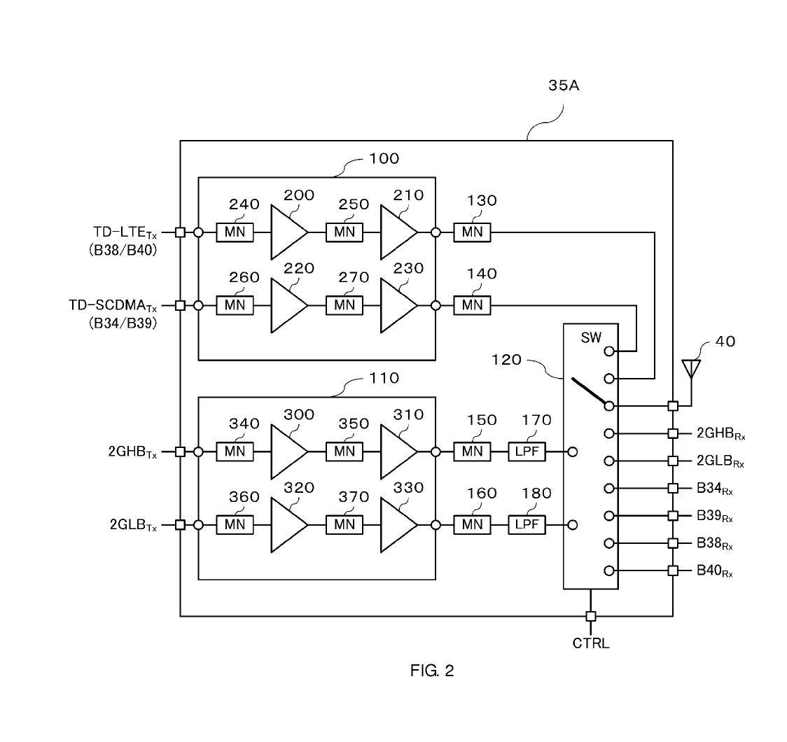

FIG. 2 is a diagram illustrating the configuration of the front-end module 35A in a first preferred embodiment of the present invention. In the configuration illustrated in FIG. 2, the front-end module 35A is compatible with four bands including a 2G low-frequency band (Low Band: LB), a 2G high-frequency band (High Band: HB), the TD-SCDMA, and the TD-LTE.

In addition, the 2GLB is, for example, about 850 MHz or about 900 MHz of the GSM, and the 2GHB is, for example, about 1800 MHz of the DCS or about 1900 MHz of the PCS. In addition, the frequency band of the TD-SCDMA is, for example, Band34(B34: about 2010 MHz to about 2025 MHz) or Band39 (B39: about 1880 MHz to about 1920 MHz). In addition, the frequency band of the TD-LTE is, for example, Band38 (B38: about 2570 MHz to about 2620MHz), Band40 (B40: about 2300 MHz to about 2400 MHz), or Band41(B41: about 2496 to about 2690 MHz). In addition, in some case, the Band41(B41: about 2496 to about 2690 MHz) is added to the frequency band of the TD-LTE.

The front-end module 35A includes input terminals for the transmission signal (TD-LTE_{Tx}) of the TD-LTE, the transmission signal (TD-SCDMA_{Tx}) of the TD-SCDMA, the transmission signal (2GHB_{Tx}) of the 2GHB, and the transmission signal (2GLB_{Tx}) of the 2GLB.

In addition, the front-end module 35A includes output terminals for the reception signal (2GHB_{Rx}) of the 2GHB, the reception signal (2GLB_{Rx}) of the 2GLB, the reception signal (B34_{Rx}) of the B34 of the TD-SCDMA, the reception signal (B39_{Rx}) of the B39 of the TD-SCDMA, the reception signal (B38_{Rx}) of the B38 of the TD-LTE, and the reception signal (B40_{Rx}) of the B40 of the TD-LTE. In addition, in some cases, an output terminal for the Band41 (B41: about 2496 to about 2690 MHz) is added to the front-end module 35A.

As illustrated in FIG. 2, the front-end module 35A includes power amplifier circuits 100 and 110, a switch circuit 120, matching circuits 130, 140, 150, and 160, and low pass filters 170 and 180.

The power amplifier circuit 100 preferably includes a semiconductor element substrate (transmission circuit) amplifying and outputting the electric powers of the RF signals (transmission signals) of the TD-LTE and the TD-SCDMA, and includes power amplifiers 200, 210, 220, and 230 and matching circuits 240, 250, 260, and 270.

Each of the power amplifiers 200, 210, 220, and 230 preferably includes an amplifying element such as a heterojunction bipolar transistor (HBT). The same applies to other power amplifiers described later. The matching circuits 240, 250, 260, and 270 are provided so as to achieve impedance matching between circuits.

The power amplifier circuit 110 includes a semiconductor element substrate (transmission circuit) amplifying and outputting the electric powers of the RF signals (transmission signals) of the 2GHB and the 2GLB, and includes power amplifiers 300, 310, 320, and 330 and matching circuits 340, 350, 360, and 370.

In addition, the number of the stages of power amplifiers in each of the power amplifier circuits 100 and 110 may not be two, and may also be three or more. In addition, the circuit configurations of the power amplifier circuits 100 and 110 may not be equal to each other. The same applies to other power amplifiers described later.

The matching circuit 130 is arranged so as to achieve impedance matching between the output of the power amplifier 210 and the input of the switch circuit 120. In the same way, the matching circuit 140 is arranged so as to achieve impedance matching between the output of the power amplifier 230 and the input of the switch circuit 120. The matching circuits 130 and 140 are configured using, for example, inductors, capacitors, or the like.

The matching circuit 150 is arranged so as to achieve impedance matching between the output of the power amplifier 310 and the input of the LPF 170. In the same way, the matching circuit 160 is arranged so as to achieve impedance matching between the output of the power amplifier 330 and the input of the LPF 180. The matching circuits 150 and 160 are configured using, for example, inductors, capacitors, or the like.

The LPF 170 and the LPF 180 are configured so as to cause RF signals of frequency bands corresponding to the 2GHB and the 2GLB, respectively, and reduce harmonic components.

The switch circuit 120 is capable of switching between the input and output of signals in response to a control signal from the control unit 30, input from a terminal CTRL. As the inputs of transmission signals, the RF signals of the TD-LTE and the TD-SCDMA, output from the power amplifier circuit 100, and the RF signals of the 2GHB and the 2GLB, output from the power amplifier circuit 110, are input to the switch circuit 120. In addition, as the input of a reception signal, an RF signal from the antenna 40 is input to the switch circuit 120. In addition, the switch circuit 120 is connected to a terminal used to output the reception signal.

Here, all the RF signals of the TD-LTE, the TD-SCDMA, the 2GHB, and the 2GLB are RF signals subjected to time-division multiplexing. Accordingly, for example, when transmission and reception in the TD-LTE are performed, the switch circuit 120 is capable of switching between the output of the RF signal (TD-LTE_{Tx}of the TD-LTE to the antenna 40, output from the power amplifier 210, and the output of the RF signal (B38_{Rx/B}40Rx) of the TD-LTE input from the antenna 40, in response to the control signal. The same applies to the communication signals of other wireless communication systems. In addition, in some cases, a switch circuit used for the TD-LTE/TD-SCDMA is separated from the switch circuit 120.

In addition, RF signals (2GHB_{Rx}, 2GLB_{Rx}, B34_{Rx}, B39_{Rx}, B38_{Rx}, and B40_{Rx}) output through the switch circuit 120 are input to the RF processing unit 25 through the BPF 45. In addition, in the BPF 45, filtering according to each frequency band is performed.

In the front-end module 35A illustrated in FIG. 2, the switching of communication signals is performed by only the one switch circuit 120. Accordingly, compared with a configuration where the switching of communication signals is performed using a plurality of switching mechanisms, it is possible to reduce the losses of the communication signals.

### Second Preferred Embodiment

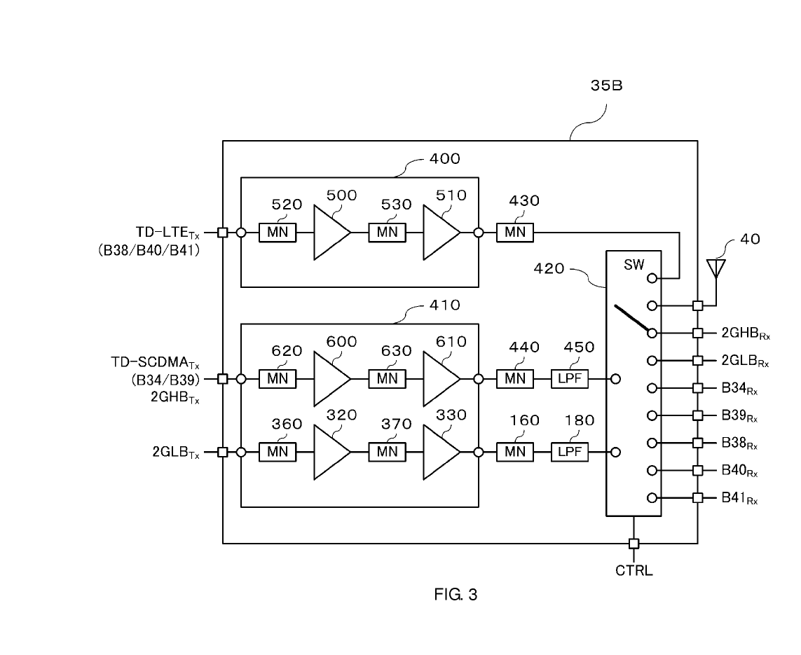

Next, a second preferred embodiment of the present invention will be described. FIG. 3 is a diagram illustrating the configuration of the front-end module 35B in the second preferred embodiment. As illustrated in FIG. 3, the front-end module 35B includes power amplifier circuits 400 and 410, a switch circuit 420, matching circuits 430, 440, and 160, and low pass filters 450 and 180. In addition, the same number is assigned to the same element as the front-end module 35A in the first preferred embodiment, and the description thereof will be omitted.

In the configuration illustrated in FIG. 3, the front-end module 35B is compatible with four different bands including the 2GLB, the 2GHB, the TD-SCDMA, and the TD-LTE. In addition, the frequency band of the TD-LTE corresponds to, for example, the Band41 (B41: about 2496 MHz to about 2960 MHz) in addition to the B38 and the B40. In addition, the frequency band of the TD-SCDMA corresponds to, for example, the B34 and the B39. In addition, in some cases, Band7 (B7: about 2500 MHz to about 2570 MHz) is contained in a frequency band with which the front-end module 35B is compatible.

The power amplifier circuit 400 is a semiconductor element substrate amplifying and outputting the electric power of the RF signal (transmission signal) of the TD-LTE, and includes power amplifiers 500 and 510 and matching circuits 520 and 530. An RF signal output from the power amplifier circuit 400 is input to the switch circuit 420 through the matching circuit 430.

The power amplifier circuit 410 preferably includes a semiconductor element substrate amplifying and outputting the electric power of the RF signal (transmission signal) of the TD-SCDMA in addition to the 2GLB and the 2GHB, and includes power amplifiers 600, 610, 320, and 330 and matching circuits 620, 630, 360, and 370. In the power amplifier circuit 410, a signal path on an upper side in FIG. 3, in other words, a signal path including the power amplifiers 600 and 610 and the matching circuits 620 and 630 corresponds to the RF signal of the TD-SCDMA and the RF signal of the 2GHB. An RF signal output from the power amplifier 610 is input to the switch circuit 420 through the matching circuit 440 and the LPF 450. In addition, a signal path on a lower side in FIG. 3 in the power amplifier circuit 410 corresponds to the RF signal of the 2GLB in the same way as in the first preferred embodiment.

In the same way as in the first preferred embodiment, the switch circuit 420 controls the switching of communication signals in response to the control signal input from the terminal CTRL.

In this way, along with the 2GHB, the TD-SCDMA is supported by the power amplifier circuit 410, and the power amplifier circuit 400 also includes only one path for the TD-LTE. Accordingly, it is possible to miniaturize the power amplifier circuit 400 and miniaturize the front-end module 35B. Also in this configuration, since the switching of communication signals is performed by only the one switch circuit 420, it is possible to reduce the losses of the communication signals, compared with a configuration where the switching of communication signals is performed using a plurality of switching mechanisms. In addition, in some cases, a switch circuit used for the TD-LTE is separated from the switch circuit 420.

### Third Preferred Embodiment

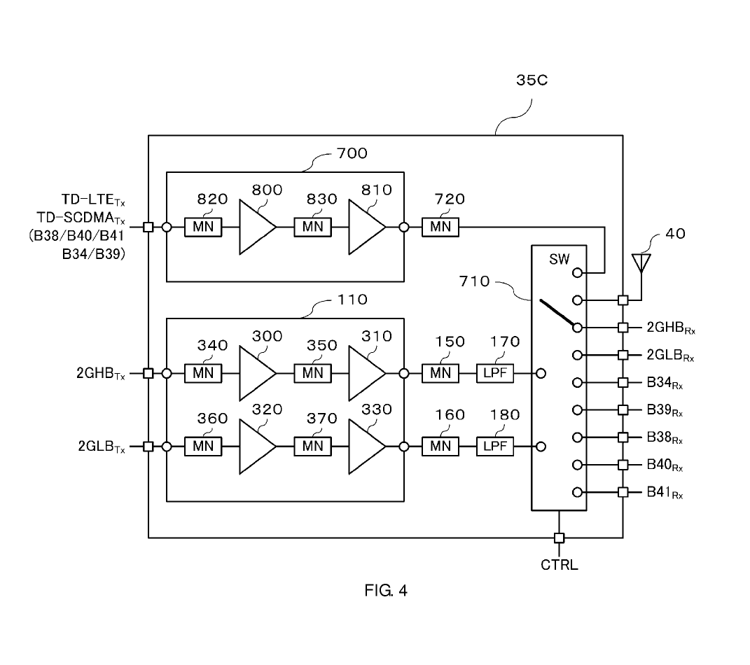

Next, a third preferred embodiment of the present invention will be described. FIG. 4 is a diagram illustrating the configuration of the front-end module 35C in the third preferred embodiment. As illustrated in FIG. 4, the front-end module 35C includes power amplifier circuits 700 and 110, a switch circuit 710, matching circuits 720, 150, and 160, and the low pass filters 170 and 180. In addition, the same number is assigned to the same element as the front-end module 35A or 35B in the first or second preferred embodiment, and the description thereof will be omitted.

In the configuration illustrated in FIG. 4, the front-end module 35C is compatible with four different bands including the 2GLB, the 2GHB, the TD-SCDMA, and the TD-LTE. In addition, the frequency band of the TD-LTE corresponds to, for example, the

B38, the B40, and the B41. In addition, the frequency band of the TD-SCDMA corresponds to, for example, the B34 and the B39. In addition, in some cases, the B7is contained in a frequency band with which the front-end module 35C is compatible.

The power amplifier circuit 700 includes a semiconductor element substrate amplifying and outputting the electric powers of the RF signals (transmission signals) of the TD-LTE and the TD-SCDMA, and includes power amplifiers 800 and 810 and matching circuits 820 and 830. An RF signal output from the power amplifier circuit 700 is input to the switch circuit 710 through the matching circuit 720. In addition, in some cases, a switch circuit used for the TD-LTE/SCDMA is separated from the switch circuit 710.

Using one communication path, the power amplifier circuit 700 deals with the TD-LTE and the TD-SCDMA. Accordingly, the matching circuit 720 provided between the power amplifier circuit 700 and the switch circuit 710 has a wider bandwidth than a matching circuit having a commonly-used configuration.

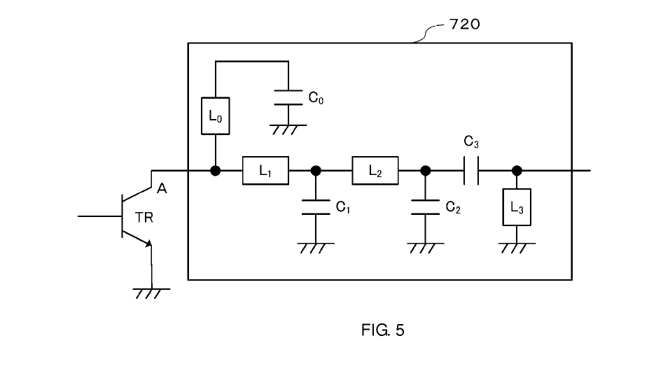

FIG. 5 is a diagram illustrating an example of the configuration of the matching circuit 720 having a wider bandwidth. As illustrated in FIG. 5, the matching circuit 720 includes inductors L₀, L₁, L₂, and L₃ and capacitors C₀, Cₗ, C₂, and C₃. In addition, the matching circuit 720 has a configuration including a low pass filter due to the inductors L₁ and L₂ and the capacitors C₁ and C₂ and a high pass filter due to the capacitor C₃ and the inductor L₃. In addition, the inductor L₃ may be configured using, for example, an air core coil. Since the air core coil has a high Q value, it is possible to prevent or significantly reduce a signal loss in the matching circuit 720 using the air core coil as the inductor L₃.

In addition, since, in the matching circuit 720, on the switch circuit 710 side, the inductor L₃ is provided where one end thereof is connected to a signal path and the other end thereof is grounded, it is possible to conduct, to a ground, static electricity entering from the antenna 40 through the switch circuit 710. In other words, it is possible to prevent or significantly reduce the destruction of a circuit, caused by the static electricity flowing into the power amplifier circuit 700.

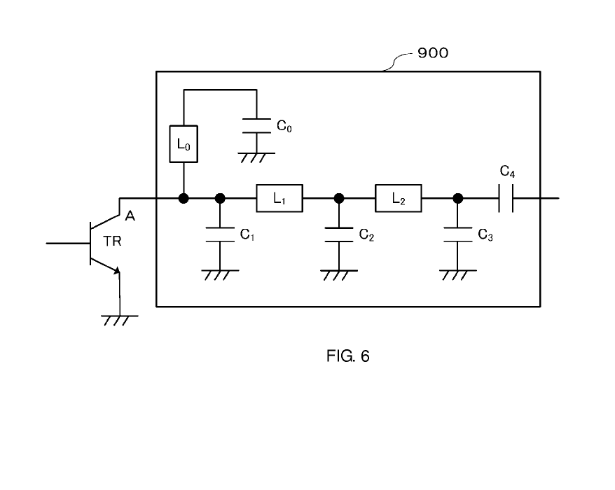

To cause the matching circuit 720 to have a wider bandwidth will be described by contrast with the configuration of a commonly-used matching circuit. FIG. 6 is a diagram illustrating an example of the configuration of a commonly-used matching circuit 900. As illustrated in FIG. 6, the matching circuit 900 includes inductors L₀, Lₗ, and L₂ and capacitors C₀, C₁, C₂, C₃, and C₄. In addition, the matching circuit 900 has a configuration including a low pass filter due to the inductors L₁ and L₂ and the capacitors C₂ and C₃. In addition, a final element on the switch circuit 710 side in the matching circuit 900 is the capacitor C₄ connected in series to a signal path.

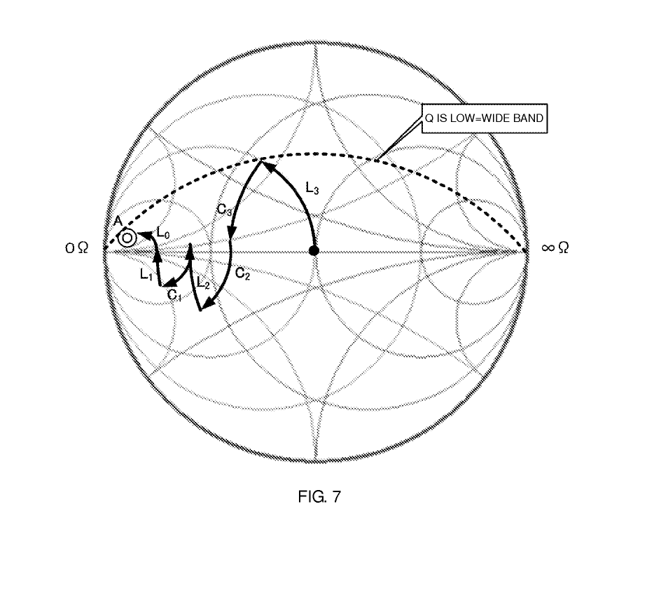

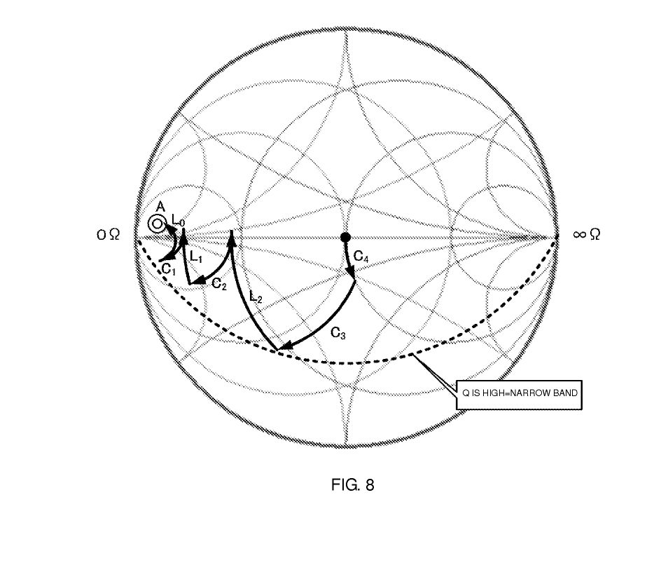

Matching topologies in the matching circuits 720 and 900 will be described using immittance charts. FIG. 7 is the immittance chart of the matching circuit 720. In addition, FIG. 8 is the immittance chart of the matching circuit 900. In addition, points A illustrated in FIG. 7 and FIG. 8 correspond to impedance in the output of the power amplifier circuit 700.

In the matching circuit 720, a final element on the switch circuit 710 side is the inductor L₃ connected in parallel to the signal path. Therefore, as illustrated in FIG. 7, a locus is drawn that moves on an equi-conductance circle from the center point of the immittance chart in a counterclockwise fashion, the length of the movement corresponding to the inductance of the inductor L₃. Since a next element is the capacitor C₃ connected in series to the signal path, a locus is drawn that moves on an equi-resistance circle in a counterclockwise fashion, the length of the movement corresponding to the capacitance of the capacitor C₃. Afterwards, in the same way, a locus is drawn, and finally reaches the point A. Accordingly, impedance matching is achieved between the output of the power amplifier circuit 700 and the input of the switch circuit 710.

In the same way, in the matching circuit 900, as illustrated in FIG. 8, a locus is also drawn from the center point of the immittance chart to the point A. In the matching circuit 900, the final element on the switch circuit 710 side is the capacitor C₄ connected in series to the signal path. Therefore, as illustrated in FIG. 8, a locus is drawn that moves on an equi-resistance line from the center point of the immittance chart in a counterclockwise fashion, the length of the movement corresponding to the capacitance of the capacitor C₄and the locus becomes a locus distanced from a target matching point. Since a next element is the capacitor C₃ connected in parallel to the signal path, a locus is drawn that moves on an equi-conductance circle in a clockwise fashion, the length of the movement corresponding to the capacitance of the capacitor C₃. Therefore, Q is higher than in FIG. 7, and a circuit whose bandwidth is narrow is obtained.

The immittance charts in FIG. 7 and FIG. 8 will be compared with each other. In FIG. 7, after having travelled on an equi-conductance line from the center point in a counterclockwise fashion, the locus travels on an equi-resistance line in a counterclockwise fashion. In other words, the locus becomes a locus moving toward a real number axis next after having travelled away from the real number axis at the beginning. On the other hand, in FIG. 8, after having travelled on an equi-resistance line from the center point in a counterclockwise fashion, the locus travels on an equi-conductance line in a clockwise fashion. In other words, the locus becomes a locus further travelling away from a real number axis after having travelled away from the real number axis at the beginning. Accordingly, in the matching circuit 720, depending on the characteristic of an inductor or a capacitor, it is easy to lower the height of the locus with reference to the real number axis, namely, a Q value, compared with the matching circuit 900. In addition, by lowering the Q value, it is possible to cause the matching circuit 720 to have a wider bandwidth.

### Fourth Preferred Embodiment

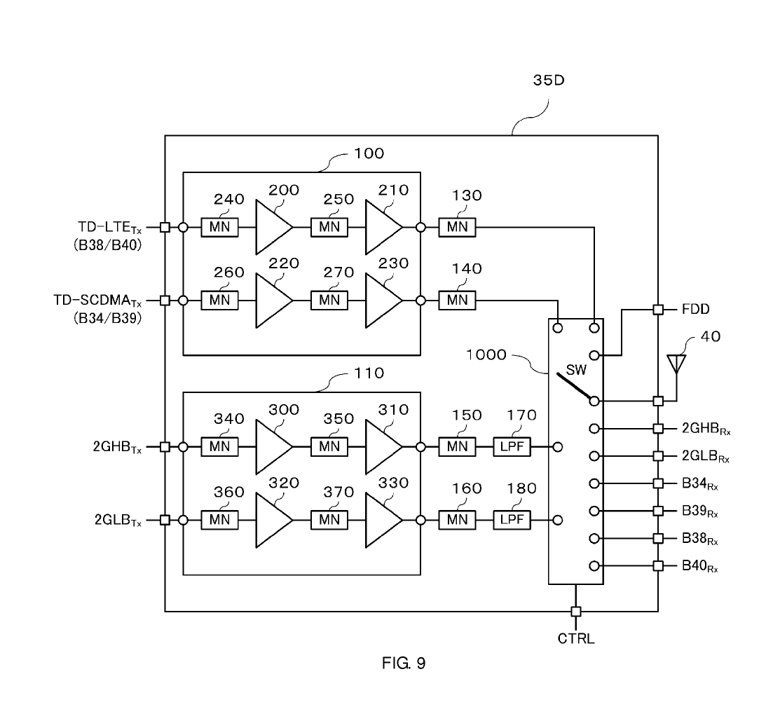

Next, a fourth preferred embodiment of the present invention will be described. FIG. 9 is a diagram illustrating the configuration of the front-end module 35D in the fourth preferred embodiment. In place of the switch circuit 120 in the front-end module 35A in the first preferred embodiment illustrated in FIG. 2, the front-end module 35D includes a switch circuit 1000. The switch circuit 1000 includes a communication path with a terminal FDD (input-output terminal) in addition to the communication paths in the switch circuit 120. A communication module, which is compatible with a frequency-division multiplexing wireless communication system and where a duplexer is desired to separating a frequency band, may be connected to the terminal FDD. In addition, the switch circuit 1000 is capable of performing the transmission and reception of a communication signal (transmission/reception signal) between the antenna 40 and the terminal FDD.

In this way, by providing the terminal FDD, it is possible to reduce the losses of communication signals in a communication unit compatible with a plurality of time-division multiplexing wireless communication systems, and it is also possible to deal with a frequency-division multiplexing wireless communication system.

In addition, the present preferred embodiments are preferably utilized to facilitate understanding of preferred embodiments of the present invention, and not utilized to understand preferred embodiments of the present invention in a limited sense. Preferred embodiments of the present invention may be modified or altered without departing from the scope thereof, and may also include the equivalents thereof.

While preferred embodiments of the invention have been described above, it is to be understood that variations and modifications will be apparent to those skilled in the art without departing from the scope and spirit of the invention. The scope of the invention, therefore, is to be determined solely by the following claims.

1. (canceled)

2. A semiconductor module comprising:
a first transmission circuit configured to output a first transmission signal of a first wireless communication system based on time-division multiplexing;
a second transmission circuit configured to output a second transmission signal of a second wireless communication system based on time-division multiplexing; and
a switch circuit configured to output a reception signal from an antenna, as a first reception signal of the first wireless communication system or a second reception signal of the second wireless communication system, output the first transmission signal and the first reception signal in a time division manner, and output the second transmission signal and the second reception signal in a time division manner.

3. The semiconductor module according to claim 2, wherein the first and second transmission circuits are located on a same semiconductor element substrate.

4. The semiconductor module according to claim 2, further comprising:
a matching circuit provided between the first transmission circuit and the switch circuit; wherein
the matching circuit includes, on a side of the switch circuit, an inductor including one end connected to a signal path and another end that is grounded.

5. The semiconductor module according to claim 4, wherein the inductor includes an air core coil.

6. The semiconductor module according to claim 2, further comprising:
an input-output terminal to and from which transmission and reception signals of a third wireless communication system based on frequency-division multiplexing are input and output; wherein
the switch circuit is arranged to connect the input-output terminal and the antenna to each other.

7. The semiconductor module according to claim 2, wherein the semiconductor module is a front-end module of a communication unit.

8. The semiconductor module according to claim 2, wherein the semiconductor module is configured to operate in a plurality of different bands.

9. The semiconductor module according to claim 8, wherein a number of the plurality of different bands is at least four.

10. The semiconductor module according to claim 8, wherein the plurality of different bands includes at least one of a 2G low-frequency band, a 2G high-frequency band, TD-SCDMA, TD-LTE.

11. The semiconductor module according to claim 2, further comprising power amplifier circuits and low pass filters.

12. The semiconductor module according to claim 11, wherein at least one of the power amplifier circuits includes a semiconductor element substrate.

13. The semiconductor module according to claim 11, wherein a number of stages in each of the power amplifier circuits is two or more.

14. The semiconductor module according to claim 11, further comprising a matching circuit arranged between at least one of the power amplifier circuits and the switch circuit to provide impedance matching.

15. The semiconductor module according to claim 11, further comprising a matching circuit arranged between at least one of the low pass filters and the switch circuit to provide impedance matching.

16. The semiconductor module according to claim 2, wherein the switch circuit is the only circuit in the semiconductor module that is arranged to perform switching of communication signals.

17. A communication unit comprising:
a baseband unit;
an RF processing unit;
a control unit;
a front end module defined by a semiconductor module according to claim 2; an antenna; and
a band pass filter.

18. The communication unit according to claim 16, wherein the communication unit is configured to operate in a plurality of different bands.

19. The communication unit according to claim 18, wherein a number of the plurality of different bands is at least four.

20. The communication unit according to claim 18, wherein the plurality of different bands includes at least one of a 2G low-frequency band, a 2G high-frequency band, TD-SCDMA, TD-LTE.
